(19) United States
(12) Patent Application Publication
(10) Pub. No.: US 2013/0003759 A1
(43) Pub. Date: Jan. 3, 2013

(54) TECHNIQUE FOR BANDWIDTH EFFECTIVE TRAFFIC PROTECTION IN COMMUNICATION NETWORKS

(76) Inventors: Andrew SERGEEV, Kfar Sava (IL); Jun YE, Hangzhou (CN); Shigang WANG, Hangzhou (CN); Shiting YU, Hangzhou (CN)

(21) Appl. No.: 13/530,944

(22) Filed: Jun. 22, 2012

(30) Foreign Application Priority Data
Jun. 30, 2011 (IL) 213893

(51) Int. Cl. H04J 3/00

(52) U.S. Cl. 370/498

(57) ABSTRACT

Technology for reducing bandwidth consumption in an Ethernet network, by dynamic selection of one copy of traffic services (per protection group) for transmitting to a remote Ethernet node from a multi-homing node. The dynamic selection is performed during a normal (full) working condition of the multi-homing node. In case the multi-homing node condition changes to a partially working condition, selection of the services per protection group depends on the remaining working facilities of the multi-homing node.

### CROSS-REFERENCE TO RELATED APPLICATIONS

This application claims priority of Israel Patent Application No. 213893, filed Jun. 30, 2011, the disclosure of which is incorporated by reference herein in its entirety.

### FIELD OF THE INVENTION

The present invention relates to a technology for protection service and equipment in modern communication networks, more specifically in Metro Ethernet networks, for example Provider Bridge (PB) networks utilizing TDM services emulation.

### BACKGROUND

For the sake of clarity and conciseness, the following abbreviations are used in the disclosure:
STM-1—a basic traffic container in Synchronous Digital Hierarchy (SDH) systems of data communication like Synchronous Optical Networking (SONET).
CES—Circuit Emulation Service, for example a Synchronous Transport Module (STM) /SONET data flow encapsulated into a flow of Ethernet packets.
MAC address—Media Access Control address is a unique identifier utilized in Ethernet networks.
MEF-8—encapsulation type for assigning MAC addresses to encapsulated E1/T1 traffic, according to “Metro Ethernet Forum 8, Implementation Agreement for the Emulation of PDH Circuits over Metro Ethernet Networks”, October 2004.
PB—Provider Bridge (network).
PG—protection group.
IWF—inter-working function.
TDM—Time-division multiplexing.

The following disclosure assumes that a CES is deployed in an Ethernet network, and that the CES encapsulation is performed according to the MEF8 recommendations. Thus forwarding operations in the Ethernet network are MAC based, however other deployments are included in the scope of the present invention.

In an example shown in FIG. 1 (prior art) a CES service is to be created with a network element C (10) being, for example a base station. Network element C is bordering a Metro Ethernet network 12 controlled by a node 14, which may be a Radio Network Controller RNC (14) of a mobile network, a Central Office (CO), etc. For purposes of traffic protection, the service passes via a dual-homed network structure (16) consisting of NE A and NE B and connecting two networks: a Time-Division Multiplexing (TDM) network and Ethernet network 12. Each network comprises several other Network Elements (NEs), for example, additional NEs are shown as empty boxes in network 12. The dual-homed network structure may receive two identical flows of traffic from the RNC 14, simultaneously via two 1+1 (or 1:1) protected links 13 and 15. The network elements (NEs) A, B, C have a capability to learn MAC addresses of arriving packets (known as bridging functionality). The network elements (NEs) A, B, C also have the capability to perform packetization of TDM data flows such as E1/T1 for forwarding the packets to Ethernet destinations (known as CES functionality). In order to ensure protection of the traffic outgoing from node 14, both before and after emulating it into the CES, the prior art solution of FIG. 1 teaches starting the traffic on an STM-1 channelized interface (as multiple streams of E1/T1 traffic streams, for example 63 logical channels of E1 streams per one STM-1 container). The STM-1 traffic is protected in a standard 1+1 manner. The 1+1 type of protection means that both lines 13 and 15 (in the TDM network 18) work simultaneously and are permanently busy carrying two equal traffic flows.

Each traffic stream E1 of these several channels arrives to both of two interfaces (16A or 16B) of the dual-homed node (16), and is fed to a respective inter-working function (IWF) in the nodes A or B. These IWF functions convert each the E1 streams into a corresponding CES traffic flow which is to be forwarded via the Ethernet network 12. In the prior art solution described in FIG. 1, the different interfaces 16A, 16B are associated with their respective groups of inter-working functions (not shown) in the nodes A, B. The two groups of IWFs are respectively connected to two TDM ports of the two nodes A and B, both of the ports receiving one and the same specific STM-1 container of the TDM traffic. The two groups of IWFs are being associated with two different MAC addresses (MAC-A and MAC-B), to enable communicating with the outer Ethernet network 12 by Ethernet packet services (CES).

According to the known solution shown in FIG. 1, the two CES traffic streams/flows, are respectively formed at A and B of the dual homed node 16. They are then forwarded along two separate trails/paths 17 and 19 via the Ethernet network 12 to the common destination node C (having address MAC-C). This configuration ensures traffic protection in the network 12, but actually transmits double traffic according to the scheme 1+1 and consumes double bandwidth.

Other solutions known in the art are using a VRRP protocol (Virtual Router Redundancy Protocol for Layer 3 (Internet) communication networks. For example, CN101420381 discloses a method for increasing transmitting reliability in load balancing of virtual routing redundancy protocol (VRRP). The method comprises the following steps: monitoring the message transmitting state of a routing device with a link fault monitoring technique, and immediately triggering and taking-over and utilizing a virtual MAC address used by the routing device when the message transmitting state of the routing device is abnormal. The virtual MAC address is used for loading a message in which the destination MAC address is the virtual MAC address, and periodically transmitting an announcement message containing the virtual MAC address in the virtual routing. The method and device described can shorten the flow interruption interval caused by failure of the device or the link to an outer network, thereby increasing the VRRP reliability.

### SUMMARY OF THE DISCLOSURE

The present invention provides rationalized traffic protection in Layer 2 (Ethernet) networks by utilizing abilities of multi-homing nodes.

It is one of the objects of the invention to achieve bandwidth efficient traffic protection in an Ethernet network, for telecommunication services such as CES which are formed at a multi-homed node interconnecting the Ethernet network, for example, with a TDM network.

Other objects of the invention will become apparent in the description of the invention.

In order to achieve the above objects, the present invention provides a specific arrangement and procedure to be performed in a multi-homed node bordering an Ethernet network and a TDM network. In case the Ethernet network comprises a remote Ethernet node (hereinafter “node C” or simply “C”) being in bidirectional communication with the multi-homed node (e.g. a specific case, a dual-homed node A-B). The multi-homed node, in turn, may be in bidirectional communication with a node of the TDM network (e.g. a radio network controller RNC residing in a central office CO), via at least two mutually protected TDM links. For example, SONET/SDH links carrying E1/T1 traffic in SONET/SDH containers or as is. In addition the multi-homing node (i.e., each of its nodes) is capable of generating flows of Ethernet packets. According to the present embodiment the multi-homing node is capable of performing encapsulation of N traffic flows of TDM data into Ethernet frames to obtain N respective CES services.

According to one embodiment of the present invention, each E1 of a specific STM-1 container received at a specific TDM port of the multi-homed node is channelized into M components E1-s, for example where M=63. Thus, the encapsulation may be performed by applying each of the M component TDM flows of a TDM data container to a corresponding inter-working function (IWF) embedded in a specific node (A,B..) of the multi-homing node.

According to another embodiment, M number of TDM traffic flows (for example, M E1-flows) may be directly applied to a specific node of the multi-homing node via respective M TDM ports, wherein the same M number of the same TDM traffic flows are applied to each of the remaining nodes of the multi-homing node. More specifically, in the case of a dual homed node (DH), a double amount of TDM traffic is received from the TDM network. Accordingly a double amount of component TDM flows is created and converted into Ethernet packets of the respective CES services, for further sending to one or more remote Ethernet nodes in the Ethernet network. The TDM traffic may be doubled by receiving the identical TDM traffic containers at the dual-homed node along two “1+1” protected TDM links. In the case illustrated in FIG. 2 a specific TDM port at node A (26A) receives a specific TDM traffic container (such as STM-1), transmitted from the TDM node 24 along link 23. The specific TDM port at node A creates 63 component E1 flows, and a similar specific TDM port at node B receiving the same TDM traffic flow/container along link 25 also creates 63 component E1 flows. As a result, each CES service created at a first node of the dual homed node has at least one, protecting CES service to respectively created in at least one remaining node of the multi-homed node, such CES services forming a match (in the case of a dual homed node—a matching pair).

According to one embodiment of the present invention, a K number of CES services can be formed in the DH node from the M component TDM flows, where K is integer (K≦M). The K number of formed CES services may be destined for one and the same node (for example, node C of the Ethernet network). Alternatively, The K number of formed CES services may be sent to different Ethernet nodes.

One of the objects of the present invention is to reduce bandwidth consumption in the Ethernet network. This object is fulfilled by a dynamic selection of one copy of traffic services (e.g. CES services), per protection group, for transmitting to the remote Ethernet node from a multi-homed node, wherein:

the dynamic selection is performed during a normal (full) working condition of the multi-horned node; while,

in case the multi-homed node condition changes to a partially working condition, selection of the traffic services per protection group depends on (becomes determined by) remaining working facilities of the multi-homed node.

The traffic services (the flows of Ethernet packets) may be formed by a multi-homed node from a protection group of TDM traffic flows fed to the multi-homed node. In this case multiple copies of the Ethernet traffic formed by the multi-homed node may also be considered a protection group corresponding to the protection group of the TDM traffic flows.

The multi-homing node (also known as a multi-homed node) is a known term in the field of communications. The multi-homing node comprises two or more interconnected nodes (network nodes) and serves for performing both the equipment and the traffic protection in modern communication networks. A multi-homed node comprising two nodes is called a dual homed node (DH node).

The traffic services mentioned above are preferably CES (Circuit Emulation Services) in the Ethernet network. The proposed method may be defined in a particular embodiment in more detail as follows:

a method for providing bandwidth effective traffic protection in an Ethernet network interconnected via a multi-homed node with a TDM network, wherein the Ethernet network comprises a remote Ethernet node being in bidirectional communication with the multi-horned node, and the multi-horned node, in turn, being in bidirectional communication with a node of the TDM network via at least two mutually protected TDM links; wherein
the multi-homing node is capable of generating CES service flows of Ethernet packets from flows of TDM traffic received via said TDM links,
and wherein at least one of the TDM traffic flows is fed to the multi-homing node via a protection group PG of TDM ports, with each port of the PG being located at a different node of the multi-homing node.

The method of this embodiment comprises dynamic selection of one copy of CES service flows per protection group, for transmitting to the remote Ethernet node, based on the quality of the TDM traffic flows and during a normal working condition of the multi-homing node and the TDM links; while, in case the condition thereof changes to a partially working condition, the method comprises selection of the CES service flows based on the remaining working facilities of the multi-homing node and the TDM links.

The TDM traffic flow may be understood as comprising one or more TDM component traffic flows (such as E1/T1). According to one embodiment, the method comprises assigning a common virtual MAC address (MAC-Pi) to each protection group PGi, for smooth relearning of MAC addresses in the Ethernet network in case of changing the copy of the CES services (changing node of the multi-homing node).

The protection group may be as restricted as a match (two) of TDM component traffic flows. In a dual homed node the match is a matching pair of the TDM flows serving the basis of a corresponding matching pair of CES services; in a triple-homed node the match is three such flows, etc. In the case of a dual-homed node, one CES service (out of two) is transmitted to the remote Ethernet node, while the dynamic selection is being performed during a normal working condition of the dual-homed node. In case the dual-horned node's and/or TDM links' condition changes to a partially working condition, the selection of one CES service per match depends on the remaining side of the dual-homed node/ TDM links.

For example, at least one protection group PG may be such a match consisting of a pair of E1/T1 services which are further encapsulated in the dual-homing node by respective IWF blocks. Members of the match may be applied to the multi-homed node directly, using respective TDM ports. For example the traffic may be applied to the multi-homed node by E1s. In another example, each said protection group (PG) comprises:
a number of TDM flows created from a flow of TDM traffic containers fed to a TDM port at a specific node of the multi-homed node; and
complementary/additional/protective TDM flows created from identical flows of TDM traffic containers respectively fed to remaining node(s) of the multi-homed node.

According to another embodiment, the present invention provides the following measures for ensuring traffic protection in the Ethernet network (instead of transmitting multi-fold CES traffic from a multi-homed node):

defining at least one said protection groups (PG) as covering CES services, where each PG(i) comprises:
CES service(s) created in a first node of the multi-homed node (e.g., in node A of the DH node) from TDM traffic flow obtained at a specific TDM port(i) of the first node; and
CES service(s) created in at least one remaining node of the multi-homed node (e.g., in node B of the DH node) from TDM traffic flow obtained at a specific TDMport(i)′ of said at least one remaining node, wherein the TDMport(i) and TDMport(i)′ being physical ports supposed to receive one and the same TDM traffic flow at different nodes of the multi-horned node;

per each PG(i), providing:
a first logical path (e.g., a virtual local area network (VLAN)) in the Ethernet network for CES services created in the first node, between said first node and a remote Ethernet node (such as node C),
at least a second logical path between said remaining node and the same remote Ethernet node, for CES services created in said remaining node, while

assigning the common virtual MAC address (MAC-Pi) to each protection group PGi, and associating it both with the TDM port(i) and TDMport(i)′;

selecting at the multi-homed node, per each match of the CES services created at different nodes of the multi-homed node, a better CES service (either directly at the output CES ports or alternatively, since the CES services are formed from respective TDM component flows, by selecting a better TDM component traffic flow per match);

outputting from the multi-homed node only the selected, better CES service per match, from the selected node of the multi-homed node, and forwarding it along the corresponding logical path (provided for the selected node);

Since each pair of TDM port(i) and TDMport(i)′ is associated with the common virtual MAC address MAC-Pi (per PG group), the selected outputted CES service of a specific protection group PG(i) will reach the remote Ethernet node (C) only once. The selected outputted CES service will be transmitted via the path established for the selected CES service (the non-selected CES service of the specific protection group PG(i) will not occupy bandwidth at the path provided for the non-selected CES service). This way the selected CES service of the specific group PG(i) will always be considered at the remote Ethernet node (C) as arriving from the MAC-Pi address.

When two or more CES services, outputted from the multi-homed node, go to the same remote node C, they most probably use the same logical path in the Ethernet network. However, the CES services may be addressed to different remote nodes C, thus their paths will be definitely different. The first and the second logical paths do not have to be selected simultaneously; they may be chosen dynamically or only partially disjoined. In addition, the first and the second logical paths do not have to be both provided in advance, for example, a second logical path may be selected when a specific CES service is decided to be created at an alternative node of the multi-homed node.

In one embodiment of the present invention, the components of the CES traffic flows are created from the components of the TDM traffic flows received at the double-homing node from a TDM network via two 1+1 TDM links, and the method may further comprise:
defining a TDM input port, at each node of the dual homed node, for each specific TDM traffic flow/container to be conducted through the double-homed node;
defining one or more said protection groups PGs as TDM protection groups grouping TDM traffic flows incoming to the multi-homed node, where each TDM protection group (i) comprises component TDM traffic flows passing via the first node (“node A”), and component TDM traffic flows passing via the second node (“node B”) of the dual-homed node;
applying each component TDM traffic flow to a corresponding IWF in a specific node of the double-homed node, thereby obtaining the corresponding CES component traffic flow; and
associating IWFs of the double-homed node, serving one and the same PGi, with one and the same MAC-Pi (e.g., the Ethernet output ports of IWFs belonging to one PGi have the same MAC-Pi).

In one example, a protection group per STM-1 container in a dual-horned node will comprise 63 E1 components of TDM traffic flows at one node, and 63 similar ones at the other node. In another example a protection group per E1 will comprise one component TDM traffic flow E1 at one node, and a similar E1 at the other node.

According to one embodiment each plurality/pair of IWFs at different nodes of the dual-homed node, handling a protection group of TDM flows, will output only a half of the supposed CES components via output ports of the dual horned node. For example, a matching pair of TDM flows will be encapsulated and outputted via Layer 2 output ports of two IWFs, so that the two logical paths selected for such a protection group PG(i) will be loaded only by bandwidth of a single CES component.

By implementing the proposed concept arrangement, the Ethernet network will be freed from extra traffic in any condition of multi-homed connections (not only when they fail). In case of a failure at one of the TDM links, ports or the corresponding node of the dual-homed node, the second link/port/node will fulfill its protection function and undertake the traffic of all said formed protection groups PGs. Also in case when the TDM links/ports and nodes of the dual homed node serving a to specific PG are in order, one of the TDM links/ports is selected based on its quality and CES flow(s) are created only from the selected TDM one.

According to another embodiment the present invention further comprises:
Deploying a protocol between nodes of the multi-homed node, for selecting and indicating a forwarding status of each of the two TDM ports of a specific PGi (the status being either main/primary or protective/secondary),
wherein each TDM port is associated with its node of the multi-homed node. The port status is decided at the TDM ports, per group PGi, either by 1+1 or by 1:1 ideology. That decision affects internal functionality of the nodes. For example it governs IWFs of which node A or B will produce CES flows, while other IWFs will remain silent.

In each group PGi of the mentioned one or more protection groups created for nodes of the multi-homed node, a main port (e.g. TDMAi) and a secondary/protecting port (e.g. TDM Bi) are determined. The virtual MAC address (MAC-P) created/assigned per each of the mentioned protection groups PG, is preferably a dedicated unicast MAC address.

Under the coordination of an operator (e.g. Network Management System NMS) being preliminarily informed about protection groups PG and virtual MAC addresses of relevant TDM ports, an embodiment of the present invention comprises the following steps for establishing bidirectional traffic via the Ethernet network:
At the remote Ethernet node (such as node C), allowing the creation of one or more CES service flows for a specific protection group PGi with a destination MAC address being MAC-Pi of the specific protection group PGi;
In each node of the multi-homing node (e.g., at node A and node B of a dual homed node), allowing the creation of one or more corresponding CES services, having a destination MAC address being MAC of the remote Ethernet node (DMAC=MAC C), and having a source MAC address being the virtual MAC address of said protection group PGi (SMAC=MAC Pi);
At the nodes of the multi-homing node, creating the CES services, by performing CES encapsulation into L2/Ethernet service frames; and
Transmitting the Ethernet service frames towards the remote node (Node C) only from one node of the multi-homing node per protection group PG. The forwarding node is the one with the local TDM port elected as a primary port in the PGi and is in working condition, where a port is elected as primary when a signal received at the port is of better quality than at a matching port(s) of the group F′Gi at the other node(s) of the multi-homed node.
In case of a failure (non-working condition) in one side of the proposed arrangement in the multi-homing node (e.g. in one of the TDM traffic links, ports or in any node of the multi-homing node), the method includes causing the protective /link/node of the other side of the arrangement to start transmitting the CES service frames towards the remote node (C). The CES service frames are transmitted according to the deployed protocol, and relearning one or more MAC Pi-s in the Ethernet network as located at the side of an alternative logical path (i.e., from the side of the healthy link/node), so as to recover the bi-directional service traffic.
Indicating over the path which becomes main/primary, that the path/node/link has become primary. In the TDM network the indication should be sent in both directions.

As obvious to any person skilled in the art, in the TDM network if side A is forwarding traffic and side B is not, the RNC (or CO or the like) need to know that it should not take traffic arriving from side B. whereas in the Ethernet network, the indication of a forwarding side is optional, since the present invention allows performing smooth self-learning of MAC addresses in the Ethernet network.

The encapsulation of component flows of the TDM traffic into the CES service frames may be made by using encapsulation described in the MEF8 standard.

According to another aspect of the invention, there is proposed a multi-homed node, each node thereof being provided with TDM ports and IWF blocks capable of encapsulating TDM traffic flows, whenever fed to the TDM ports, into Ethernet frames. Here, a TDM port in a specific node of the multi-homed node forms a protection group PG with one or more TDM ports respectively provided in the remaining nodes of the multi-homed node for receiving and protecting identical TDM traffic flows. The multi-homed node comprising
monitoring means for monitoring the quality of TDM traffic flows at the TDM ports; and
a control logical unit adapted for dynamically selecting, from TDM traffic flows fed in parallel to the TDM ports of one protection group, either a better quality traffic flow or the only existing traffic flow.

The multi-homed node is adapted to output the Ethernet packets created from TDM traffic flows received at TDM ports of one and the same protection group from one node of the multi-homed node.

The internal IWF blocks associated with TDM ports belonging to one and the same protection group PG, and handling Ethernet traffic of the same PG, are preferably associated with one and the same virtual MAC address.

According to yet another aspect of the invention, there is proposed a software product comprising computer implementable instructions and/or data for carrying out the method described above, stored on an appropriate non-transitory computer readable storage medium (for example, in the control block of the multi-homed node) so that the software is capable of enabling operations of said method when used in a computer system. For example, the computer system where the software product resides comprises a control block of the multi-homed node and a network management system NMS etc. (having knowledge about the virtual addresses and managing operation of the multi-homed node and a remote Ethernet node).

### BRIEF DESCRIPTION OF THE DRAWINGS

The above invention will be further described and illustrated with the aid of the following non-limiting drawings in which:

FIG. 1 (prior art) is a schematic block of a system implementing a conventional version for interconnecting, with protection, an external TDM network and an L2 network via a dual homing structure.

FIG. 2 is a schematic block diagram of one possible implementation of the present invention, where a protection group of services are transmitted between an L2 network and a TDM network is created in a dual homing node, per TDM physical port.

FIG. 3 is a schematic block diagram that illustrates an example of how protection groups of CES flows can be formed in a dual-homed node A-B.

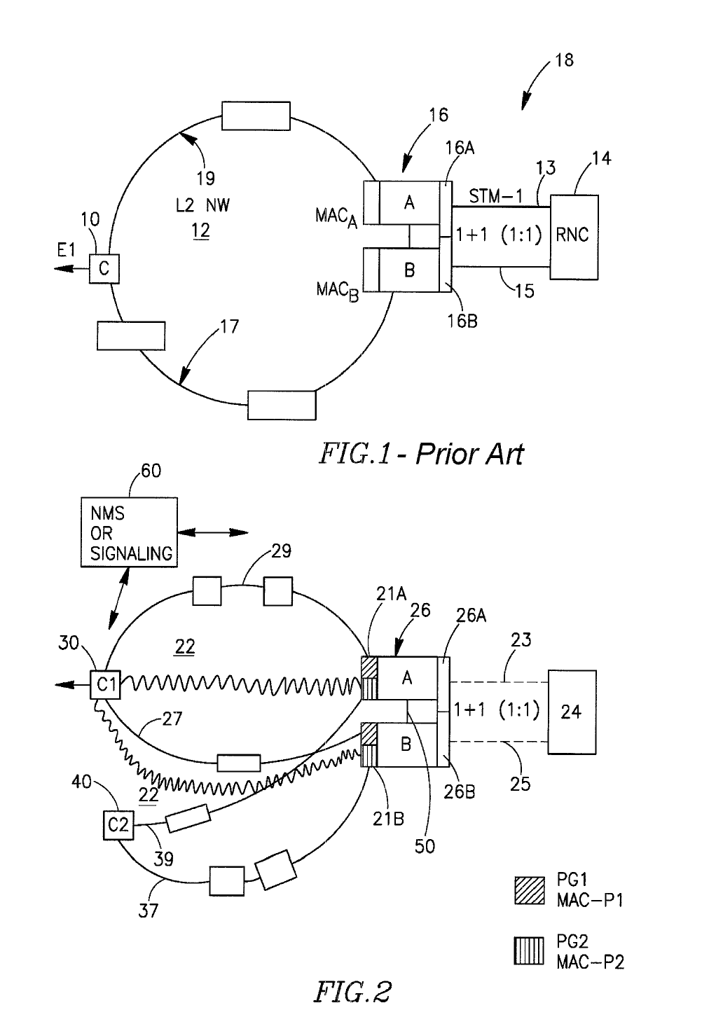

### DETAILED DESCRIPTION OF THE DISCLOSURE

FIG. 2 illustrates an Ethernet network 22, comprising two remote nodes C1 (30) and C2 (40) which are in bidirectional communication with a dual homed node 26 (A-B). The dual homed node 26 may receive two identical flows of TDM traffic from a TDM node 24, simultaneously via two 1+1 (or 1:1) protected links 23 and 25. Each of the TDM flows is channelized at its respective interface 26A and 26B of node 26 into component TDM flows. Component TDM flows are encapsulated in a specific half of the node 26 (e.g., in A) into CES component flows which can be then outputted via respective ports of an array of CES ports A (21A) and forwarded to the Ethernet network via logical paths (27, 29, 37, 39 are shown). The manner which the specific half of the node is selected for forwarding traffic to the Ethernet network, is described below.

A connection 50 between nodes A and B is a logical path in the L2 network, similar to paths 27, 37, 39. The connection 50 serves, for example, for signaling between nodes A and B such as protocol messages to select primary and secondary side of the node. Connection 50 may also serve for Ethernet traffic including the own CES traffic which might be forwarded over this connection, for example in case of a fiber cut in the Ethernet network. In addition Network Management System (NMS) or another signaling system 60 provides to nodes 26, 30 and 40 with information as described below.

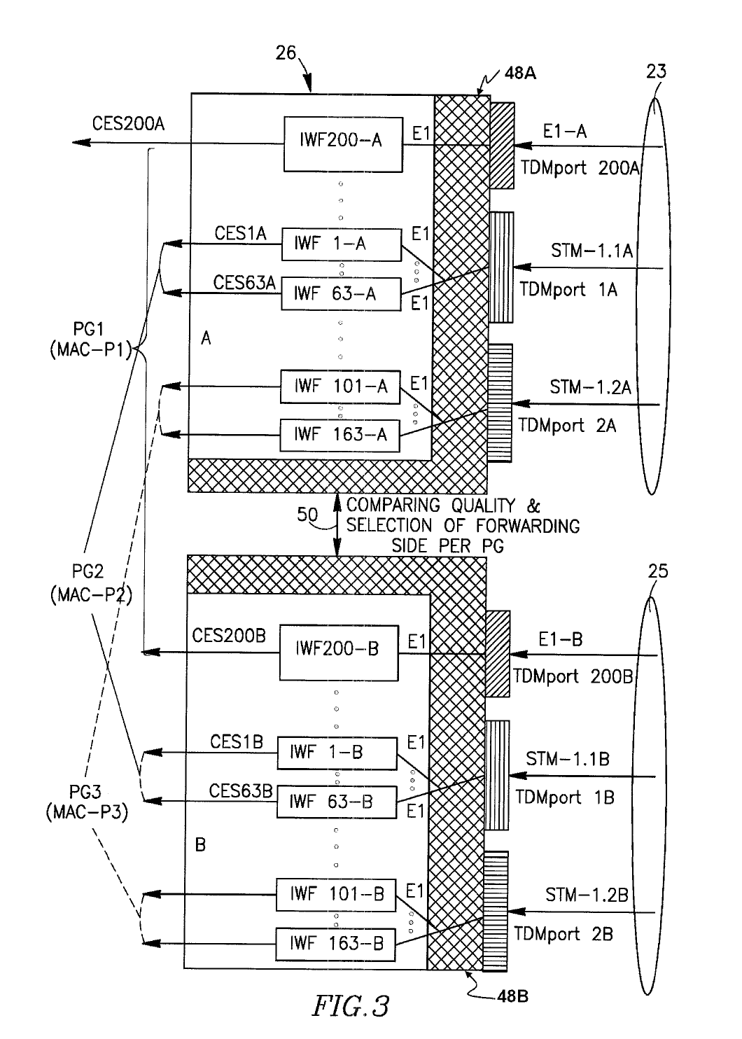

In a schematic example shown in FIG. 3, node A of the double-homed node 26 has three TDM ports:

TDMport 1A which receives a TDM flow STM-1.1A;

TDMport 2A which receives a TDM flow STM-1.2A and

TDMport 200A which receives a TDM flow E1-A.

All the TDM flows are transmitted from node 24 (as shown in FIG. 2) via link 23. Node B of the double-homed node 26 also has three TDM ports:

TDMport 1B which receives a TDM flow STM-1.1B;

TDMport 2B which receives a TDM flow STM-1.2B; and

TDMport 200B which receives a TDM flow E1-B

All the TDM flows are transmitted from node 24 via link 25.

Each of the nodes A, B comprises IWF (interworking functions) for performing encapsulation of TDM traffic flows. In the example shown in FIG. 3 the TDM traffic flows are represented as E1 flows. A separate traffic flow E1-A that arrives at node A via link 23 through a TDM physical port TDMport 200A. Concurrently, an identical traffic flow E1-B arrives at node B vial link 25 and through port TDMport 200B. The two matching flows E1-A and E1-B are respectively applied to IWF200-A and IWF200-B, and form a first protection group PG1. Thus, as shown in FIG. 3 the CES traffic flows CES200A and CES200B, respectively resulting from TDM flows E1-A and E1-B form the protection group PG1 in the Ethernet network. According to one embodiment of the invention, the TDMport200A and the TDMport200B of group PG1 have one and the same virtual MAC address MAC-P1.

A protection traffic group 2 (PG2) comprises:

63 CES flows formed at node A (from one TDM container STM-1.1A arriving to TDMport 1A along TDM link 23, channelized into 63 E1 flows and encapsulated in 63 blocks “IWF 1-A” to “IWF 63-A”); and

63 CES flows formed at node 13 (from the TDM container STM-1.1B, arriving to TDMport 1B along TDM link 25 and channelized into 63 E1 flows further converted by blocks “IWF 1-B” to “IWF 63-B”).

Since the same STM-1.1 is transmitted via two 1+1 links (23 and 25) and arrives to the respective TDM ports of nodes A and B, the resulting CES flows are grouped into protection group PG2. The group (and more specifically, the two TDM ports: TDMport 1A and TDMport 1B) has one virtual unicast MAC address MAC-P2 for PG2.

Similarly, a protection traffic group 3 (PG3) is formed for M CES flows formed at node A (from a TDM container STM-1.2A arriving to TDMport 2A along TDM link 23 and channelized into M+1 . . . 2M E1 flows), and M CES flows formed at node B (from the identical TDM container STM-1.2B arriving to TDMport 2B along TDM link 25 and channelized into M+1 . . . 2M E1 flows). Since one and the same STM-1.2 transmitted via two 1+1 links 23 and 25 arrives to the TDM ports TDMport 2A and TDMport 2B, the resulting CES flows are grouped into protection group PG3, and the two TDM ports have one and the same assigned virtual unicast MAC address MAC-P3 for PG3.

A protocol, for selecting a forwarding node/TDMport/TDMlink when one of the nodes/ports/links fails, is deployed in the dual-homed node 26 and signaling between nodes A and B is supported along the communication path 50. According to another embodiment of the invention protocol an additional sub-protocol is provided for allowing selection of a better quality signal arriving to the TDM ports of one and the same protection group (i.e., having one and the same virtual MAC address). When the TDM links, ports and the dual homing node equipment are all in order, the sub-protocol allows selecting only a representative portion of data flows of the protection group for forwarding this representative portion to its destination/destinations in the Ethernet network.

In FIG. 3, although monitoring/selecting blocks and CPU are not explicitly shown inside the nodes A and B, they are schematically represented as shaded fields 48A, 48B. The monitoring/selecting blocks and CPU comprise embedded firmware/software units which, together with a firmware/software control logical unit of the multi-homed node 26, accommodate the software protocol of the present invention governing behavior of the node 26. Upon exchanging information between the nodes along the path 50, only CES200A will be outputted from the dual homed node 26 if E1-A is better in quality than E1-B.

Protection groups of CES flows/TDM ports are marked by similar hatching per group. The selection of CES flows performed at the side of TDM traffic may activate only those IWF blocks which serve better E1 traffic flows among their respective matching pairs at the other node. Alternatively, the selection is based on an explicit indication in the corresponding SONET/SDH overhead bytes as defined in automatic protection signaling APS for 1+1 or 1:1 cases.

Returning to FIG. 2, irrespective of the condition of the node 26 and the links 23, 25, only one of the CES traffic flows of PG1 (wherein PG1 is related to a specific pair of TDM ports at the interfaces 26A, 26B) is forwarded, with protection, to the remote node C1. According to the present invention the CES traffic flow which is forwarded to node C1 is the CES traffic flow selected as a better one, or the only CES traffic flow that is available (in case of a fault). Based on which CES traffic flow is selected, the forwarding is performed either via logical path 29 or via logical path 27.

A different protection group (PG2) of CES services, related to another pair of TDM ports, is shown to be interconnected with a remote node C2 (40) via logical paths 37 and 39. However, PG2 is supposed to comprise a plurality of component CES flows (see FIG. 3). First of all, it should be noted that if some of the components are not required, only some of the 63 IWFs may be activated. Secondly, different CES flows of the same PG2 may be sent to the same C2 via respective different paths (not shown in the figure). Thirdly, some specific CES services of the group PG2 may be predestined for another remote node and, for example, be forwarded to C1 (shown as waved lines in FIG. 2).

Referring to the specific example shown in FIG. 2, the present invention can be used as follows: The provided protocol is deployed between nodes (A and B) of the dual-homed node 26, for selecting and indicating a forwarding status (primary or protective) of each specific TDM port in a specific node of the dual homed node 26.

Then, at least one Protection Group (per TDM port) is created for nodes A and B, the PG comprising a main TDM port and a mate/protecting TDM port. Each such port is associated with a number of corresponding interworking functions IWF of this node. In node A there are M number of IWFs for one TDM port all working for respective specific E1, and all IWFs of the node have one and the same MAC. The present invention suggests that the MACs will be assigned per Protection Group, and that selection is to be provided for choosing a better quality TDM signal at TDM ports per group. In addition logics in the A, B nodes may be adapted to analyze quality of individual E1 flows.

A new, dedicated unicast, named virtual MAC address (MAC-P) is assigned per protection group PG (i.e., to the L2 output ports of IWF blocks belonging to the same group PGi). At the remote Ethernet node (e.g., Node C1) a CES service is established in one direction of a bidirectional service, with a destination MAC being MAC-P1.

In each node A and B of the multi-homing node 26 there may be a control unit to create a matching CES service, having a destination MAC address being an MAC of the remote node (DMAC1=MAC C1), and having a source MAC address being the virtual MAC address of the protection group PG1 (SMAC=MAC P1).

Network Management System (NMS) or another signaling system 60 provides all necessary information to nodes 26, 30 and 40, including the virtual MAC addresses, for establishing the required bidirectional services.

The CES service is created by performing CES encapsulation into L2 service frames, at both nodes of the DH node using IWF embedded blocks, while transmitting the produced service frames towards the remote node (Node C1, C2) only from one node of the multi-homing node. The forwarding node is the one with the local TDM port selected as a primary port in a specific protection group PG (due to the better quality of its TDM flow), if it is in the working condition.

A node (A or B) works as a forwarding node for a specific PG group of flows. For another PG, another node may work as a forwarding node, since the selection of better quality data flows is permanently performed and the data flows are independent from one another.

All of the above-described processes proceed normally when both of the TDM links 23, 25 (1+1) and/or both nodes A, B are in their working condition. In case one of the TDM links fails, the forwarding node will become the one connected to the operating link (for all IWF functions/ports thereof, and selection of the E1s/CESs having the better quality becomes unnecessary). The protective elements (TDM link, node of the multi-homing node) will start transmitting the CES service frames towards its destination remote node (C1, C2), according to the deployed protocol of exchanging the forwarding status. Signaling on the status may be performed in many known various manners which need not be discussed in the frame of the present application.

Relearning of the MAC P(i) address in the Ethernet network 22 (i.e. the dynamically selected path) will be made depending upon the side from which the packets arrive to any Ethernet node so as to fulfill/recover of the bi-directional service traffic. For example, the MAC P(i) address of the side will be selected either because of better quality of traffic or because of the status of the TDM link. Obviously if node A sent traffic to node C1 in the past, and now node B starts to send traffic to node C1, the paths in the network have changed. In addition, another intermediate NE in the working logical path will now be associated by node Cl with the virtual address MAC-P (e.g., MAC-P1), as well as associated with another physical TDM port in node 26. Encapsulation of the STM-1 traffic into the CES service frames can be made by using standard MEF8 encapsulation.

Though the invention has been described with reference to specific examples, it should be appreciated that other versions of the proposed technique may be proposed, which would be applicable to cases of multi-homed nodes comprising more than two nodes, for traffic services different than the described ones, etc. Such versions of the technology should be considered part of the invention, which is defined by the claims which follow.

1. A method of reducing bandwidth consumption in an Ethernet network comprised of:
dynamically selecting one copy of Ethernet traffic service flows formed by a multi-homed node from a protection group of Time-division multiplexing (TDM) traffic flows;
transmitting the selected copy to a remote Ethernet node from said multi-homed node;
wherein during a normal working condition of the multi-homed node the dynamic selection is performed per protection group; and
during a partially working condition where the case of the condition changes, said selection is based on the remaining working facilities of the multi-homed node.

2. The method according to claim 1, for bandwidth effective traffic protection in the Ethernet network interconnected via the multi-homed node with a TDM network,
wherein the Ethernet network comprises the remote Ethernet node being in bidirectional communication with the multi-homed node, and the multi-homed node, in turn, being in bidirectional communication with a node of the TDM network via at least two mutually protected TDM links;
wherein the multi-homed node is capable of generating said Ethernet traffic service flows from TDM traffic flows received via said TDM links; and
wherein at least one of the TDM traffic flows is fed to the multi-homed node as the protection group via a corresponding protection group (PG) of TDM ports, each port of the PG being located at a different node of the multi-homed node;
the method comprises
during a normal working condition of the multi-homed node and the TDM links dynamically selecting one copy of the service flows per protection group, for transmitting to the remote Ethernet node, based on the quality of the TDM traffic flows; and
in case the condition changes to a partially working condition, selecting said service flows based on remaining working facilities of the multi-homed node and the TDM links.

3. The method according to claim 1, wherein each of the TDM traffic flows comprises one or more TDM component traffic flows.

4. The method according to claim 1, comprising assigning a common virtual Media Access Control (MAC) address (MAC-Pi) to each protection group.

5. The method according to claim 2, wherein said service flows are Circuit Emulation Services (CES) and wherein the method further comprises the following steps:
per each specific PG(i), providing
a first logical path in the Ethernet network for CES services created in a first node of the multi-homed node and associated with a TDM port TDM port(i) of said specific PG(i), between said first node and a remote Ethernet node,
at least a second logical path between said remaining node and the same remote Ethernet node, for CES services created in said remaining node and associated with another TDM port TDMport(i)′ of said specific PG(i);
assigning a common virtual MAC address (MAC-Pi) to each protection group PGi, and associating said virtual MAC address both to the TDM port(i) and TDMport(i)′;
selecting at the multi-homed node, per each PG, a better copy of the CES services associated with a specific node of the multi-homed node;
outputting from the multi-homed node only the selected, better copy of the CES services from thus selected node of the multi-homed node, and forwarding the better copy along the corresponding logical path provided for the selected node.

6. A software product comprising computer implementable instructions and/or data for carrying out the method according to claim 1, stored on an appropriate computer readable non-transitory storage medium so that the software is capable of enabling operations of said method when used in a computer system

7. A multi-horned node, each node thereof being provided with TDM ports and inter-working function (IWF) blocks capable of encapsulating TDM traffic flows, whenever fed to the TDM ports, into Ethernet frames;
wherein a TDM port in a specific node of the multi-homed node forms a protection group PG with one or more TDM ports respectively provided in remaining nodes of the multi-horned node for receiving and protecting identical TDM traffic flows;
the multi-homed node comprising:
a monitoring means for monitoring quality of TDM traffic flows at the TDM ports, and
a control logical unit adapted for dynamically selecting, from TDM traffic flows fed in parallel to the TDM ports of one protection group, either a better quality traffic flow or the only existing traffic flow;
wherein the multi-homed node thereby being adapted to permanently output the Ethernet packets, created from TDM traffic flows received at TDM ports of one and the same protection group, only from one node of the multi-homed node.

8. The multi-homed node according to claim 7, wherein the TDM ports of one and the same said PG are associated with the same virtual MAC address.
